(19) United States
(12) Patent Application Publication
(10) Pub. No.: US 2015/0303852 A1
(43) Pub. Date: Oct. 22, 2015

(54) THE ENGINE-DRIVEN GENERATOR ROTATIONAL SPEED CONTROL METHOD

(71) Applicants: Shanghai Huaxing Digital Technology Co., Ltd., Shanghai (CN); Sany Heavy Machinery Limited, Jiangsu (CN)

(72) Inventors: Jianming Wang, Jiangsu (CN); Xiaoming Liao, Jiangsu (CN)

(73) Assignee: Sany Heavy Machinery Limited, Jiangsu (CN)

(21) Appl. No.: 14/356,473

(22) PCT Filed: Dec. 4, 2012
(86) PCT No.: PCT/CN2012/085829

§ 371 Date: May 6, 2014

(30) Foreign Application Priority Data
Sep. 24, 2012 (CN) 201210357599.5

(51) Int. Cl. H02P 9/04

(52) U.S. Cl. CPC H02P 9/04

(57) ABSTRACT

This present invention discloses an engine-driven generator rotational speed control method. The method comprises the following steps, obtaining n-IA1 curve, n-IA2 curve, n-DCLV curve and DCLV-n curve through the generator open-loop characteristic curve; determining whether the current work area of the generator is the saturation area, the transition area or the linear area, and meanwhile determining the 1.1-times DCLV work area. The present invention adjusts the generator objective rotational speed by determining the state of the generator, and outputs the generator objective rotation rotational speed by the method of dynamic discrete, so as to ensure the responsiveness of the DC output voltage of the generator, to extend the service life of the generator, and to make the generator work in a more efficient state.

### CROSS-REFERENCE TO RELATED APPLICATIONS

The present application claims the priority of the Chinese application number 201210357599.5, filed on Sep. 24, 2012, the disclosure of which is herewith incorporated by reference in its entirety.

### TECHNICAL FIELD

The present invention relates to the technical field of the engine-driven generator, and particularly to an engine-driven generator rotational speed control method.

### BACKGROUND OF THE TECHNICAL

The engine operating state is the main reference to the adjustment of the engine-driven generator objective rotational speed, i.e. the objective engine speed is adjusted according to the engine load and engine operating environment (temperature, atmospheric pressure, etc.).

An current engine-driven generator is capable of providing output margin which responses quickly for load changes. The objective conduction angle is set to less than the maximum conduction angle range by adjusting the objective conduction angle, which makes the generator output margin available and provides a stable voltage and responses quickly to the load changes, so as to achieve the purpose of adjusting the generator rotational speed.

However, the generator also has the following disadvantages:

1. The adjustment of engine objective rotational speed only references to the engine temperature, load condition without considering the generator state, thereby it will affect the responsiveness of the DC output voltage of the generator;

2. The engine output margin did not take the mutual influence among DC output voltage of the generator, rotational speed of the generator and generator excitation current into consideration;

3. The settings of the objective conduction angle relates to the temperature which needs a large number of experimental data for demarcating;

4. The continuously adjustment of the objective conduction angle will cause frequent adjustment of engine rotational speed, which can increase the engine fuel consumption and affect the stability of the output DC voltage of the generator.

### SUMMARY OF THE INVENTION

In order to solve the problems that the adjustment of current engine-driven generator objective speed without considering the operating state of the generator, this issue will affect the responsiveness of the DC output voltage of the generator, and the engine output margin without taking the mutual influence among DC output voltage of the generator, rotational speed of the generator and generator excitation current into consideration, as well as the generator objective conduction angle settings complex, inconvenient adjustment problems.

This application provides an engine-driven generator rotational speed control method. Specific technical proposal are as follows:

An method for controlling the engine-driven generator rotational speed, wherein it comprises the following steps, obtaining the following curves through the generator open-loop characteristic curve:

curve 1 is used to determine the boundary between the generator depth saturation area and the generator transition area, the actual rotational speed of the generator is served as an abscissa and the equivalent excitation current of the generator is served as an ordinate;

curve 2 is used to determine the boundary between the generator linear area and the generator transition area, and the actual rotational speed of the generator is served as an abscissa and the equivalent excitation current of the generator is served as an ordinate.

curve 3 is used to determine the boundary between the generator linear area and the generator transition area, the actual rotational speed of the generator is served as an abscissa and the objective DC output voltage of the generator is served as an ordinate.

curve 4 is the reverse curve of curve 3, the objective DC output voltage is served as an abscissa and the actual rotational speed of the generator is served as an ordinate;

Determining whether the current work area of the generator is in the saturation area, the transition area or the linear area, and meanwhile determining the work area of the first-multiple objective DC output voltage value of the generator;

If the work area of the generator is in the saturation area, curve 4 is discretized in accordance with the second-multiple discrete voltage step length, curve 4 is inquired in accordance with the first-multiple objective rotational speed of the generator so as to obtain the objective rotational speed of the generator; if the work area of the generator is in the transition area, curve 4 is discretized in accordance with the discrete voltage step length, curve 4 is inquired in accordance with the first-multiple objective rotational speed of the generator so as to obtain the objective rotational speed of the generator, if the work area of the generator is in the linear area, the objective rotational speed of the generator maintains unchanged.

Furthermore, the first multiple is 1.1, and the second multiple is two.

Furthermore, if the work area of the 1.1-times objective DC output voltage of the generator is in the transition area, curve 4 is discretized in accordance with the discrete voltage step length, curve 4 is inquired in accordance with the 1.1-times objective rotational speed of the generator so as to obtain the objective rotational speed of the generator.

Further, the current objective DC output voltage is obtained in accordance with the actual rotational speed value by inquiring curve 3, if the sum of the objective DC output voltage of the generator and discrete voltage step length is less than the current objective DC output voltage, then curve 4 is discretized in accordance with the discrete voltage step length, curve 4 is inquired in accordance with the 1.1-times objective rotational speed of the generator so as to obtain the objective rotational speed of the generator.

Further, wherein, if the sum of the objective DC output voltage of the generator and discrete voltage step length the discrete voltage step length is more than the current objective DC output voltage, then the objective rotational speed of the generator maintains unchanged.

In comparison with the current technical, the above mentioned engine-driven generator rotational speed control method has the following advantages: the rotational speed of the generator is adjusted by determining the operating state of the generator to output a objective rotational speed of the generator with the dynamic discrete method, to ensure the responsiveness of the DC output voltage of the generator, to extend the service life of the generator, and to enable the generator to work in a more efficient state.

### BRIEF DESCRIPTIONS OF THE DRAWINGS

In order to illustrate the technical solutions of the embodiment of the present invention more clearly, The following will give a brief introduction of the drawings that is needed for the descriptions of embodiment, obviously, the following drawings described are only some embodiments of the present invention, to the person of ordinary skill in this area, without paying any creativity Under the premise of labor, but also can be obtain other drawings in accordance with these Figs.

FIG. 1 is an n-IA2 curve chart of the engine-driven generator rotational speed control method according to an embodiment of the present invention;

FIG. 2 is an n-IA1 curve chart of the engine-driven generator rotational speed control method according to an embodiment of the present invention;

FIG. 3 is an n-DCLV curve chart of the engine-driven generator rotational speed control method according to an embodiment of the present invention;

FIG. 4 is a DCLV-n curve chart of the engine-driven generator rotational speed control method according to an embodiment of the present invention;

various labels in the Figs are defined as follows:
1. discrete value 2. test value.

### DESCRIPTIONS OF THE PREFERRED EMBODIMENT

To make the objective, technical solutions and advantages of the present invention more apparent, the Embodiment of the present invention will be further illustrated in combination with the drawings.

The embodiments of the present invention provide an engine-driven generator rotational speed control method, the generator equivalent excitation current IA, the objective DC output voltage of the generator (DCLV) and the actual rotational speed of the generator n so as to determine the current operating state.

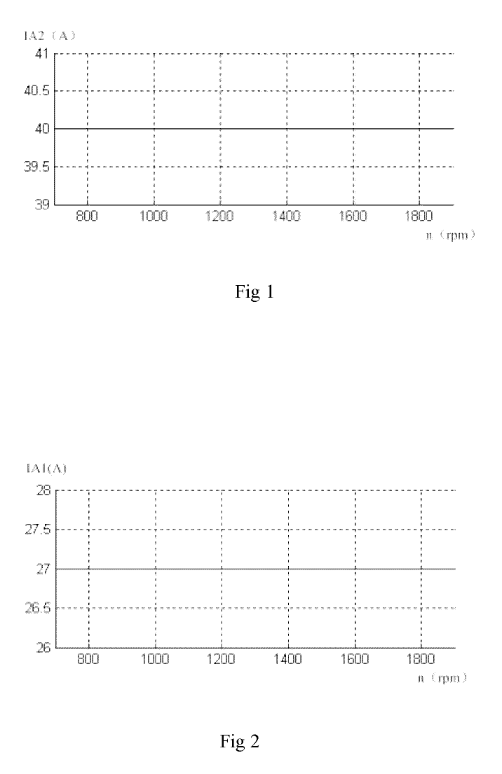

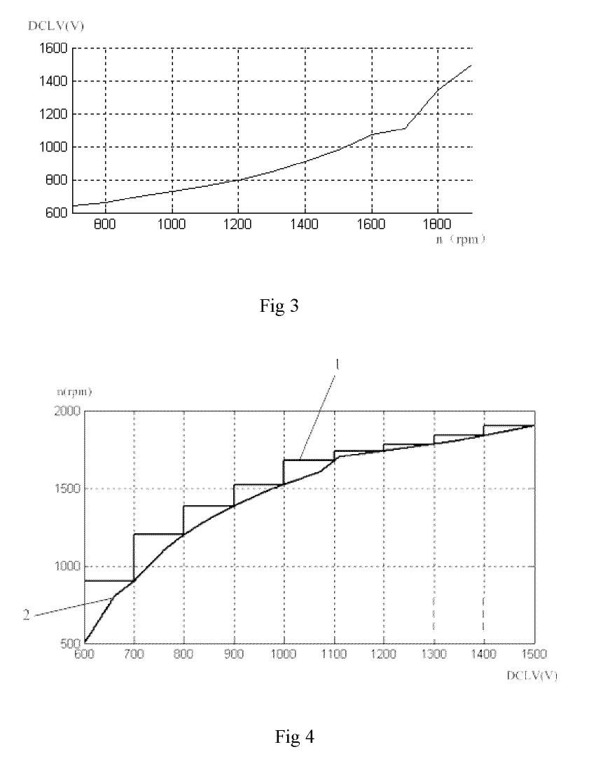

Firstly, for determining the current operating state area of the generator, the generator open-loop characteristic curve is used for obtaining the curves in FIG. 1, FIG. 2 and FIG. 3. FIG. 1 (n-IA2) shows the critical line between the depth of the saturation area and the transition area on the generator open-loop characteristic curve, and FIG. 2 (n-IA1) and FIG. 3 (n-DCLV) shows the critical line between the linear area and the transition area on the generator open-loop characteristic curve.

Secondly, the data in the above mentioned drawings is used for determining whether the current work area of the generator is the saturation area, the transition area or the linear area. Meanwhile the work area of the objective DC output voltage DCLV of the first-multiple generator is determined. After the current operating state and the future operating state of the generator are determined, the objective rotational speed of the generator is calculated. The calculation of the objective rotational speed of the generator is achieved by inquiring FIG. 4 (DCLV-n) according to the determination result, wherein FIG. 4 is a reverse curve of FIG. 3.

According to the above mentioned determination result, if the current operating state of the generator is in the saturation area, then FIG. 4 is discretized based on the second-multiple discrete voltage step length, FIG. 4 is inquired based on the first times DCLV, the objective rotational speed of the generator n * is exported. If the current operating state of the generator and the first-multiple DCLV are in the transition area, then FIG. 4, is discretized in accordance with the discrete voltage step length, and FIG. 4 is inquired in accordance with the first-multiple DCLV, the objective rotational speed of the generator n * is exported. If the sum of the objective DC output voltage of the generator and step length of the discrete voltage is less than the DC output voltage of the generator DCLV * from FIG. 3, then FIG. 4 is inquired in accordance with the discrete voltage step length, and FIG. 4 is inquired in accordance with the first-multiple DCLV, the objective rotational speed of the generator n * is exported. If the sum of the objective DC output voltage of the generator and step length of the discrete voltage is larger than the DC output voltage of the generator DCLV * from FIG. 3, the objective rotational speed of the generator n * maintains unchanged.

As a preferred situation, the first multiple is 1.1-times, and the second multiple is two times.

The disclosed embodiment of the invention the engine-driven generator rotational speed control method adjusts the generator objective rotational speed of the generator by determining the operating state of the generator. The dynamic discrete method is used for outputting the objective rotational speed of the generator, which has the following advantages:

1. the generator open-loop characteristic curve is completely utilized, the current and future operating state of the generator is considered to adjust the objective rotational speed of the generator and to ensure the responsiveness of the DC output voltage of the generator;

2. The output of the generator objective rotational speed is used for preventing the generator is in a saturation area, the service life of the generator is extended and the generator is in a more efficient state;

3. The objective rotational speed of the generator is exported in a discrete table inquiring way, and it enables the objective rotational speed of the generator output to serve as a series of discrete values, such that the engine rotational speed is not adjusted continuously and frequently, which helps stabilizing the DC output voltage of the generator;

4. The adjustment of the generator objective rotational speed is reversed with sufficient margin of the generator output capability, so that it can output stable voltage and response to the load changes quickly;

5. The experimental data of the present invention are obtained by the generator open-loop characteristic curve, which is convenient to obtain the experimental table data.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof

### INDUSTRIAL APPLICABILITY

The present invention discloses an engine-driven generator rotational speed control method, adjusting the rotational speed of the generator by determining the operating state of the generator, to output a objective rotational speed of the generator with the dynamic discrete method, so as to ensure the responsiveness of the DC output voltage of the generator, to extend the service life of the generator and to make the generator in a more efficient state. Accordingly, the present invention has industrial applicability.

1. An method for controlling the engine-driven generator rotational speed, wherein it comprises the following steps, obtaining the following curves through the generator open-loop characteristic curve:
curve 1 is used to determine the boundary between the generator depth saturation area and the generator transition area, the actual rotational speed of the generator is served as an abscissa and the equivalent excitation current of the generator is served as an ordinate;
curve 2 is used to determine the boundary between the generator linear area and the generator transition area, and the actual rotational speed of the generator is served as an abscissa and the equivalent excitation current of the generator is served as an ordinate.
curve 3 is used to determine the boundary between the generator linear area and the generator transition area, the actual rotational speed of the generator is served as an abscissa and the objective DC output voltage of the generator is served as an ordinate.
curve 4 is the reverse curve of curve 3, the objective DC output voltage is served as an abscissa and the actual rotational speed of the generator is served as an ordinate;
determining whether the current work area of the generator is in the saturation area, the transition area or the linear area, and meanwhile determining the work area of the first-multiple objective DC output voltage value of the generator;
if the work area of the generator is in the saturation area, curve 4 is discretized in accordance with the second-multiple discrete voltage step length, curve 4 is inquired in accordance with the first-multiple objective rotational speed of the generator so as to obtain the objective rotational speed of the generator; if the work area of the generator is in the transition area, curve 4 is discretized in accordance with the discrete voltage step length, curve 4 is inquired in accordance with the first-multiple objective rotational speed of the generator so as to obtain the objective rotational speed of the generator, if the work area of the generator is in the linear area, the objective rotational speed of the generator maintains unchanged.

2. The method as disclosed in claim 1, wherein the first multiple is 1.1, and the second multiple is two.

3. The method as disclosed in claim 1, wherein if the work area of the 1.1-times objective DC output voltage of the generator is in the transition area, curve 4 is discretized in accordance with the discrete voltage step length, curve 4 is inquired in accordance with the 1.1-times objective rotational speed of the generator so as to obtain the objective rotational speed of the generator.

4. The method as disclosed in claim 2, wherein the current objective DC output voltage is obtained in accordance with the actual rotational speed value by inquiring curve 3, if the sum of the objective DC output voltage of the generator and discrete voltage step length is less than the current objective DC output voltage, then curve 4 is discretized in accordance with the discrete voltage step length, curve 4 is inquired in accordance with the 1.1-times objective rotational speed of the generator so as to obtain the objective rotational speed of the generator.

5. The method as disclosed in claim 4, wherein, if the sum of the objective DC output voltage of the generator and discrete voltage step length the discrete voltage step length is more than the current objective DC output voltage, then the objective rotational speed of the generator maintains unchanged.
